(19) United States
(12) Patent Application Publication
(10) Pub. No.: US 2025/0004811 A1
(43) Pub. Date: Jan. 2, 2025

(54) SYSTEM AND METHOD FOR HOST SERVER BASED DATA PROCESSING UNIT LOGGING

(71) Applicant: VMWARE, INC., Palo Alto, CA (US)

(72) Inventors: Sunil Kumar Kotian, San Jose, CA (US); Adithya Uligere Narasimhamurthy, Longmont, CO (US)

(21) Appl. No.: 18/217,470

(22) Filed: Jun. 30, 2023

(51) Int. Cl. G06F 9/455

(52) U.S. Cl. CPC G06F 9/45558; G06F 2009/4557; G06F 2009/45583

(57) ABSTRACT

System and computer-implemented method allocates log buffers at a host server, receives log data from a data processing unit (DPU) that is connected to the host server and stores the log data in the log buffers at the host server, and transmits the log data stored in the log buffers back to the DPU to be stored in storage of the DPU such that the host server is used to temporarily store the log data.

### BACKGROUND

Data processing units (DPUs), which may also be referred to as SmartNICs (NIC stands for Network Interface Card) or infrastructure processing units (IPUs), can be integrated into a network device, for example, a network adapter, to perform various operations, such as Input/Output (I/O) operations, storage operations, network service operations, and/or security operations. DPUs are typically connected to a host server over a network interface, such as a Peripheral Component Interconnect Express (PCIe) interface and are primarily managed by the host server that acts similarly to a master. A host server can monitor the health, life cycles and power cycles of DPUs that are connected to the host server.

DPUs typically have limited local storage. For example, DPUs may have flash-based storage (e.g., soldered embedded MultiMediaCards (eMMCs)) as the primary boot and storage device. However, a flash-based storage (e.g., an eMMC) based on, for example, NAND technology may be susceptible to wear as log data generated by an operating system (OS) and other modules in a DPU translates to random writes to the flash-based storage. The random nature of log writes can result in higher write amplification (WAF), thus failing a storage device before its specified end of life (EOL). To elaborate further, flash-based storage (e.g., eMMCs) typically has a flash translation layer (FTL), which writes data to the underlying media in terms of pages, which are much larger (e.g., 512 kilobytes (KB)) than blocks (e.g., 512 bytes) that can be addressed separately for read and write operations. Consequently, when a write operation is performed on a block, a corresponding FTL must read the rest of the blocks in a page, erase the page and write the full page with new and old data together. This process of read, erase and write is also referred as write amplification, which is measured by a Write Amplification Factor (WAF). If a write pattern is sequential, a FTL can buffer a full page and write the full page without having to read the data that is already present in memory, which can affect the WAF. However, if data write operations are random in nature, the WAF can be extremely high. In a real-world scenario, Input/Output (IO) patterns for a flash-based storage are hardly sequential, and manufacturers typically specify the number of erase cycles supported by the flash-based storage (i.e., flash life), considering a mixed workload scenario. Consequently, extensive logging by the OS and other modules in a DPU can result in random write operations to various regions of a flash-based storage (e.g., eMMCs) of the DPU, thus increasing the WAF. Since there is typically no file system in a DPU, every log statement that is written out can result in a write to a flash-based storage (e.g., eMMCs) of the DPU, thus degrading the life of the flash-based storage and accelerating the EOL of the flash-based storage. When a storage device of a DPU fails, the entire DPU can become unusable, which may lead to a catastrophic failure of the DPU. Since the flash-based storage is typically soldered on the board, it cannot be replaced on the field, hence requiring the entire unit to be replaced.

### SUMMARY

System and computer-implemented method allocates log buffers at a host server, receives log data from a DPU that is connected to the host server and stores the log data in the log buffers, and transmits the log data stored in the log buffers back to the DPU to be stored in storage of the DPU such that the host server is used to temporarily store the log data.

A computer-implemented method in accordance with an embodiment of the invention comprises at a host server, allocating a plurality of log buffers, at the host server, receiving log data from a DPU that is connected to the host server and storing the log data in the log buffers, and at the host server, transmitting the log data stored in the log buffers back to the DPU to be stored in storage of the DPU such that the host server is used to temporarily store the log data. In some embodiments, the steps of this method are performed when program instructions contained in a computer-readable storage medium are executed by one or more processors.

A system in accordance with an embodiment of the invention comprises memory and at least one processor configured to allocate a plurality of log buffers, receive log data from a DPU and store the log data in the log buffers, and transmit the log data stored in the log buffers back to the DPU to be stored in storage of the DPU such that the host server is used to temporarily store the log data.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 illustrates a computing system with a host server and at least one DPU in accordance with an embodiment of the invention.

FIG. 2 shows a host server based DPU logging operation in which the host server and the DPU depicted in FIG. 1 boot up.

FIG. 3 shows a host server based DPU logging operation in which the host server depicted in FIG. 1 obtains the page size of the DPU depicted in FIG. 1.

FIG. 4 shows a host server based DPU logging operation in which the host server depicted in FIG. 1 reserves or allocates log buffers.

FIG. 5 shows a host server based DPU logging operation in which the host server depicted in FIG. 1 notifies the DPU depicted in FIG. 1 that the log buffer setup is complete and the DPU starts to transmit log data to the host server to be stored in the log buffers.

FIG. 6 shows a log transmission operation from the DPU depicted in FIG. 1 to the host server depicted in FIG. 1 and a log message write operation from the host server to the DPU.

FIG. 7 shows an example of the log message write operation depicted in FIG. 6.

FIG. 8 shows another example of the log message write operation depicted in FIG. 6.

FIG. 9 shows an emergency notification operation from the DPU depicted in FIG. 1 to the host server depicted in FIG. 1 to notify the host server that the DPU has crashed or failed, and a log message write operation from the host server to the DPU.

FIG. 10 shows an on-demand log collection operation from the DPU depicted in FIG. 1 to the host server depicted in FIG. 1 and a log message write operation from the host server to the DPU.

FIG. 11 is a flow diagram of a computer-implemented method in accordance with an embodiment of the invention.

FIG. 12 is a flow diagram of a computer-implemented method in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

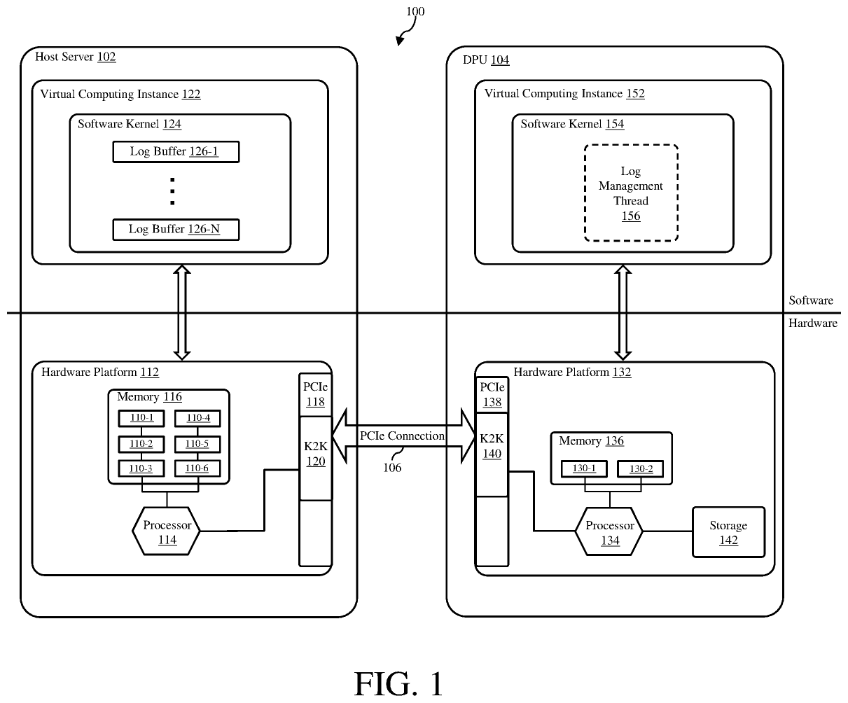

Turning now to FIG. 1, a computing system 100 in accordance with an embodiment of the invention is illustrated. The computing system 100 includes a host server 102 and at least one DPU 104. As described in detail below, communication is conducted between the host server 102 and the DPU 104 via a PCIe connection 106 so that the host server 102 can communicate with the DPU 104 for various operations. In some embodiments, the DPU 104 is managed by the host server 102, and thus, the communication connections are used by the host server 102 to access the DPU 104 to execute management operations.

The host server 102 may be constructed on a hardware platform 112, which can be a computer hardware platform, such as an x86 architecture platform. As shown, the hardware platform of the host server 102 may include components of a computing device, such as one or more processors (e.g., central processing units (CPUs)) 114, one or more memory 116, and a network interface 118. The processor 114 can be any type of a processor commonly used in computers or servers. The memory 116 can be volatile memory used for retrieving programs and processing data. The memory 116 may include memory units 110-1, 110-2, 110-3, 110-4, 110-5, 110-6, which may be, for example, random access memory (RAM) modules. However, in other embodiments, the memory 116 may include more than or less than six memory units. The network interface 118, which may be a PCIe interface, enables the host server to communicate with the DPU 104 via a communication medium, such as a network cable. The network interface 118 may include one or more network adapters, also referred to as network interface cards (NICs). In some embodiments, the network interface 118 includes a kernel-to-kernel (K2K) interface 120 that enables the host server to communicate with the DPU 104 for internal kernel-to-kernel communication. In some embodiments, the host server includes storage that may include one or more local storage devices (e.g., one or more hard disks, flash memory modules, solid state disks and/or optical disks), which may be used to form a virtual storage area network (SAN).

The host server 102 may be configured to provide a virtualization layer that abstracts processor, memory, storage and networking resources of the hardware platform 112 into at least one virtual computing instance 122. The virtual computing instance 122 may be a virtual host, for example, a VMware ESXi™ host. In the illustrated embodiment, the virtual computing instance 122 includes a software kernel 124, for example, a VMware ESXi™ kernel configured or programmed to execute various operations. As an example, the software kernel 124 may be configured or programmed to deploy, update, delete and otherwise manage components in the host server 102 and/or the DPU 104. The software kernel 124 can execute software instructions or threads and include software modules. For example, the software kernel 124 may include one or more log buffers or virtual buffers 126-1, . . . , 126-N, where N is a positive integer. In some embodiments, the virtual computing instance 122 includes a virtual machine that runs on top of a software interface layer, which is referred to herein as a hypervisor. One example of the hypervisor that may be used in an embodiment described herein is a VMware ESXi™ hypervisor provided as part of the VMware vSphere® solution made commercially available from VMware, Inc. The hypervisor may run on top of the operating system of the host server 102 or directly on hardware components of the host server 102. For other types of virtual computing instances, the host server 102 may include other virtualization software platforms to support those virtual computing instances, such as Docker virtualization platform to support “containers.”

The DPU 104 may be constructed on a hardware platform 132, which can be a computer hardware platform. As shown, the hardware platform of the DPU 104 may include components of a computing device, such as one or more processors (e.g., CPUs or microcontrollers) 134, one or more memory 136, a network interface 138, and storage 142. The processor 134 can be any type of a processor commonly used in computers or devices. The memory 136 can be volatile memory used for retrieving programs and processing data. The memory 136 may include memory units 130-1, 130-2, which may be, for example, RAM modules. However, the memory 136 may include more than or less than two memory units. The network interface 138, which may be a PCIe interface, enables the DPU 104 to communicate with the host server 102 via a communication medium, such as a network cable. The network interface 138 may include one or more network adapters, also referred to as NICs. In some embodiments, the network interface 138 includes a K2K interface 140 that enables the DPU 104 to communicate with the host server 102 for internal kernel-to-kernel communication. In some embodiments, the storage 142 may include one or more local storage devices (e.g., one or more hard disks, flash memory modules such as embedded MultiMediaCards (eMMCs), solid state disks (SSDs) and/or optical disks). In some embodiments, the storage is a flash-based storage device. For example, the storage includes one or more eMMCs.

The DPU 104 may be configured to provide a virtualization layer that abstracts processor, memory, storage and networking resources of the hardware platform 132 into at least one virtual computing instance 152. The virtual computing instance 152 may be a virtual agent, for example, a VMware ESXio agent. In the illustrated embodiment, the virtual computing instance 152 includes a software kernel 154, for example, a VMware ESXio kernel configured or programmed to execute various operations. As an example, the software kernel 154 may be configured or programmed to deploy, update, delete and otherwise manage components in the DPU 104. The software kernel 154 can execute software instructions. For example, the software kernel 154 may execute or host a software thread, for example, a log management thread 156 configured or programmed to process log data, store log data into the storage 142, and/or transmit log data, for example, to the host server 102. In some embodiments, log data is any informational or system diagnostic messages such as debug information necessary to troubleshoot potential failures, or messages that are informational in nature that indicate the operations performed by the system. Examples of the log data may include, without being limited to, device driver logs and other kernel logs. Sample logs may include: 2023-03-16T02:05:01.160Z cpu6:1000316237)Vol3: GetAttributesVMFS6:471: ‘OSDATA-60d4b734-ald9dfe7-b935-0c42a198b4a8’: 0f/25u/25t LFB, 9322f/0u/12800t SFB, 2023-03-16T02:05:01.160Z cpu6:1000316237)Vol3: GetAttributesVMFS6:471: ‘OSDATA-60d4b734-ald9dfe7-b935-0c42a198b4a8’: 0f/25u/25t LFB, 9322f/0u/12800t SFB, 2023-03-16T02:05:16.246Z cpu3:1000212553)NetVsi: DCBPFCCfgSet:21860: Device vmnic0 PFC Cfg updated, 2023-03-16T02:05:16.246Z cpu3:1000212553)NetVsi: DCBPFCEnable:21662: Device vmnic0 PFC State set to 0, 2023-03-16T02:05:19.919Z cpul:1000210721)DVFilter: DVFilterDestroyDisconnTimeoutFilters:7320: Checking disconnected filters for timeouts, 2023-03-16T02:05:46.244Z cpu0:1000212553)NetVsi: DCBPFCCfgSet:21860: Device vmnic0 PFC Cfg updated, 2023-03-16T02:05:46.244Z cpu0:1000212553)NetVsi: DCBPFCEnable:21662: Device vmnic0 PFC State set to 0. In the computing system 100 depicted in FIG. 1, the K2K interface 120 of the host server 102 may communicate with the K2K interface 140 of the DPU 104 for internal communication between the software kernel 124 of the host server 102 and the software kernel 154 of the DPU 104.

In a typical DPU implementation, a flash-based storage (e.g., eMMCs) is used as the primary boot and storage device. However, extensive logging by the OS and other modules in a DPU can result in random write operations to various regions of a flash-based storage (e.g., eMMCs) of the DPU, thus increasing the write amplification (WAF) and degrading the life of the flash-based storage and accelerating the EOL of the flash-based storage. When a storage device of a DPU fails, the entire DPU can become unusable, which may lead to a catastrophic failure of the DPU.

In accordance with an embodiment of the invention, the host server (e.g., the processor 114 executing program instructions from the software kernel 124 of the virtual computing instance 122) allocates log buffers 126-1, . . . , 126-N (e.g., in the software kernel 124 of the virtual computing instance 122 using the memory 116 of the host server), receives log data from the DPU 104 that is connected to the host server and store the log data in the log buffers, and transmits the log data stored in the log buffers back to the DPU to be stored in the storage 142 of the DPU, which may be a flash-based storage device (e.g., one or more eMMCs). By leveraging the hardware platform 112 and the virtual computing instance 122 of the host server 102 (e.g., a host infrastructure including hardware components, such as, RAM and storage), random write operations to the storage 142 of the DPU 104 can be reduced. Consequently, the degrading of the life of the storage 142 and accelerating of the EOL of the storage 142 caused by random write operations can be alleviated, the stability of the DPU 104 can be improved, and the failure rate of the DPU 104 can be reduced. For example, using the PCIe connection 106, DPU logs can be up streamed to the memory 116 (e.g., a cache located in host RAM) and periodically downloaded to the DPU to be written to the storage 142 (e.g., eMMCs) of the DPU 104, which can reduce the frequency of write operations to eMMCs on the DPU and thereby prolong the life of eMMCs. For example, the DPU may run ESXIO while the host server runs ESXI OS and is responsible for provisioning and managing the DPU through a connection. Consequently, the write amplification can be kept low as log files are always written as full pages, thus making writes at the corresponding FTL layer faster. Because of low write amplification, the life of the storage 142 of the DPU 104 is extended beyond regular usage, thus protecting the storage from the random nature of write operations that vary widely based on a system load.

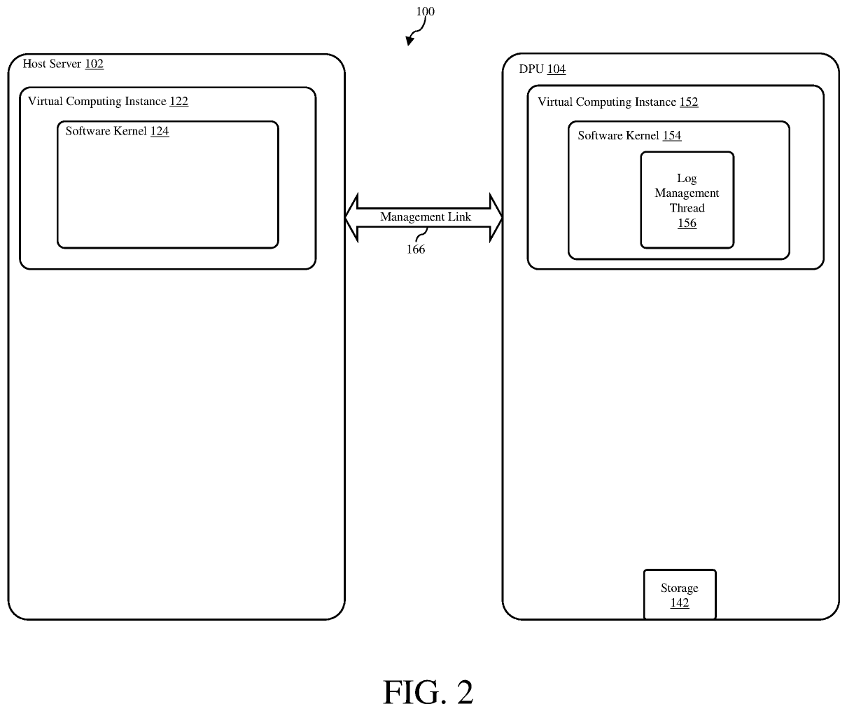

Host server based DPU logging operations in the computing system 100 in accordance with an embodiment of the invention are described with reference to FIGS. 2-10. In the host server based DPU logging operations depicted in FIGS. 2-10, log data from the DPU 104 is stored in one or more log buffers of the host server 102 and transferred back to the DPU 104 as needed to be stored in the storage 142 of the DPU such that the host server is used to temporarily store the log data. Consequently, random write operations to the storage 142 of the DPU are reduced, the life of the storage 142 of the DPU is extended beyond regular usage, and the stability of the performance of the DPU is improved. For simplicity, selected elements of the host server 102 and the DPU 104 are shown in FIGS. 2-10.

The host server based DPU logging operations begin in FIG. 2. Specifically, FIG. 2 depicts a host server based DPU logging operation in which the host server 102 and the DPU 104 depicted in FIG. 1 boot up. A management link 166 is established between the host server 102 and the DPU 104. For example, the DPU may run ESXIO while the host server runs ESXI OS and is responsible for provisioning and managing the DPU. The management link 166 may be a virtual link through which the ESXI OS running on the host server can communicate with the ESXIO running on the DPU.

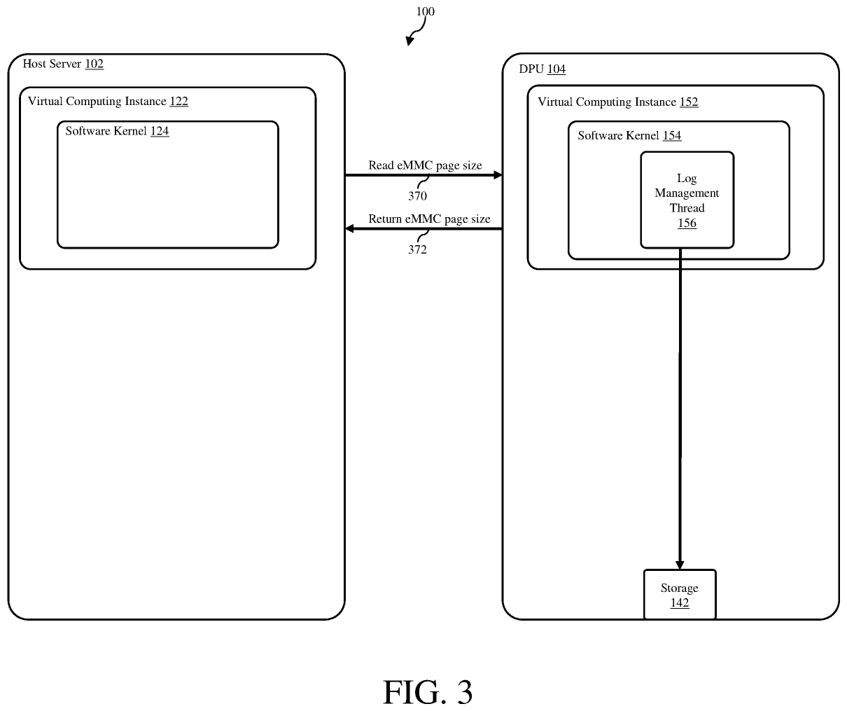

After bootup, the host server based DPU logging operations continue in FIG. 3. Specifically, FIG. 3 depicts a host server based DPU logging operation in which the host server 102 depicted in FIG. 1 obtains the page size of the DPU 104 depicted in FIG. 1. As shown in FIG. 3, the host server 102 (e.g., the processor 114 executing program instructions from the software kernel 124 of the virtual computing instance 122) reads or requests eMMC page size of the storage 142 of the DPU in operation 370 and the DPU (e.g., the processor 134 executing program instructions from the software kernel 154 of the virtual computing instance 152) returns the requested eMMC page size (e.g., 512 KB) of the storage 142 to the host server in operation 372, for example, through the management link 166 established between the host server 102 and the DPU 104.

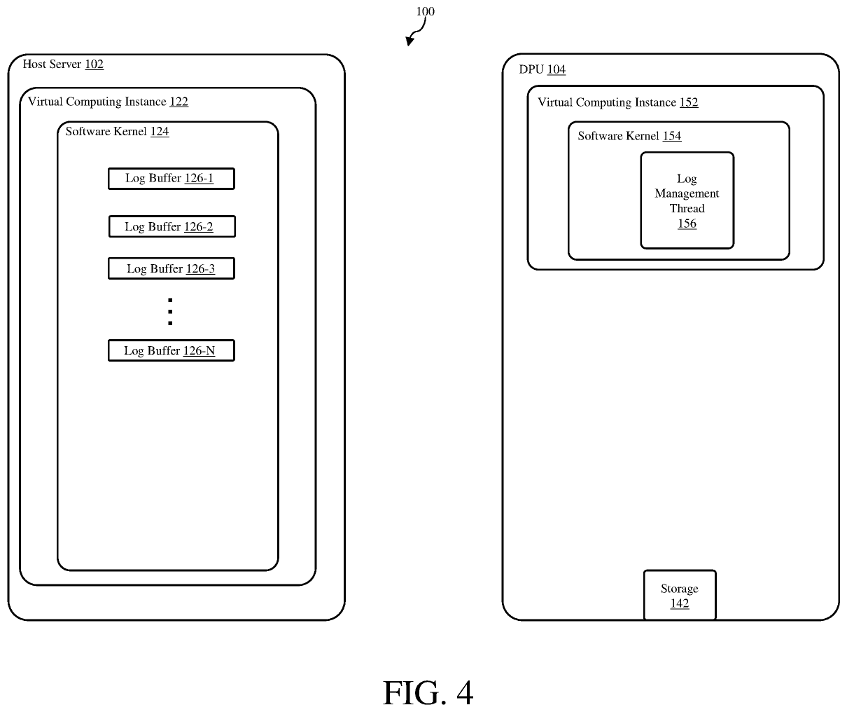

After the host server 102 obtains the page size/erase size of the DPU 104, the host server based DPU logging operations continue in FIG. 4. Specifically, FIG. 4 depicts a host server based DPU logging operation in which the host server depicted in FIG. 1 (e.g., the processor 114 executing program instructions from the software kernel 124 of the virtual computing instance 122) reserves or allocates the log buffers 126-1, . . . , 126-N, where N is a positive integer, in the software kernel 124 of the virtual computing instance 122 of the size equivalent to the eMMC page size (e.g., 512 KB) on the memory 116 of the hardware platform 112 of the host server 102 (e.g., RAM modules of the memory 116). In some embodiments, the size of one or all of the log buffers 126-1, . . . , 126-N is identical to the page size of the storage 142 of the DPU, for example, the eMMC page size (e.g., 512 KB).

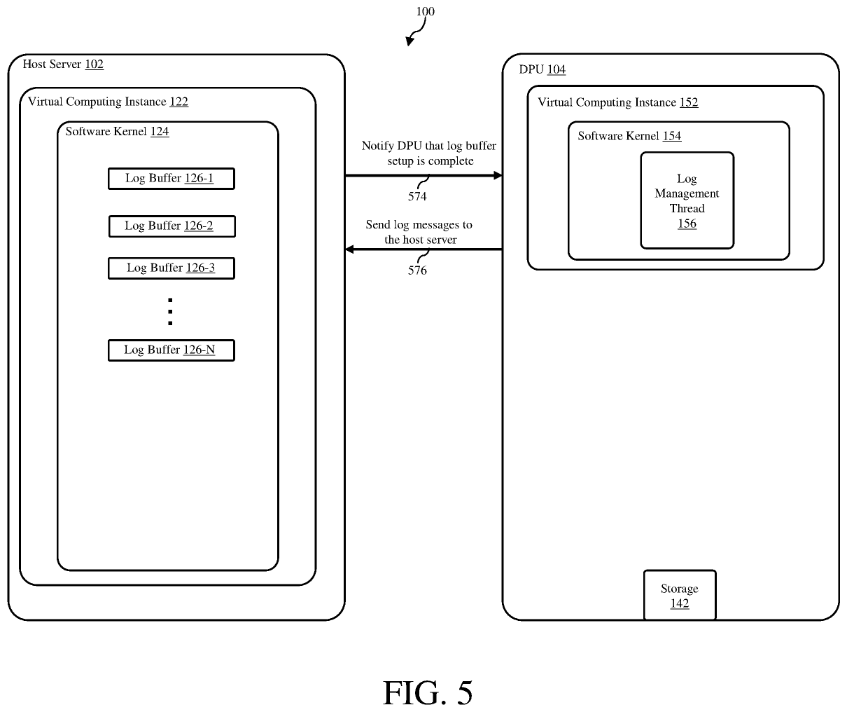

After the host server 102 reserves or allocates log buffers, the host server based DPU logging operations continue in FIG. 5. Specifically, FIG. 5 depicts a host server based DPU logging operation in which the host server depicted in FIG. 1 (e.g., the processor 114 executing program instructions from the software kernel 124 of the virtual computing instance 122) notifies the DPU depicted in FIG. 1 that the log buffer setup is complete and the DPU (e.g., the processor 134 executing program instructions from the software kernel 154 of the virtual computing instance 152) starts to transmit log data to the host server to be stored in the log buffers 126-1, . . . , 126-N. For example, once the host server notifies the DPU that the log buffer setup is complete in operation 574, the DPU starts forwarding log messages to the host server using a log forwarding mechanism through the management link 166 in operation 576. In some embodiments, all of the logs of the DPU are forwarded to the host server to assure log data completeness. The host server stores the received logs in the dedicated log buffers 126-1, . . . , 126-N and can transmit the one or more stored logs back to the DPU to be written back at a later point in time.

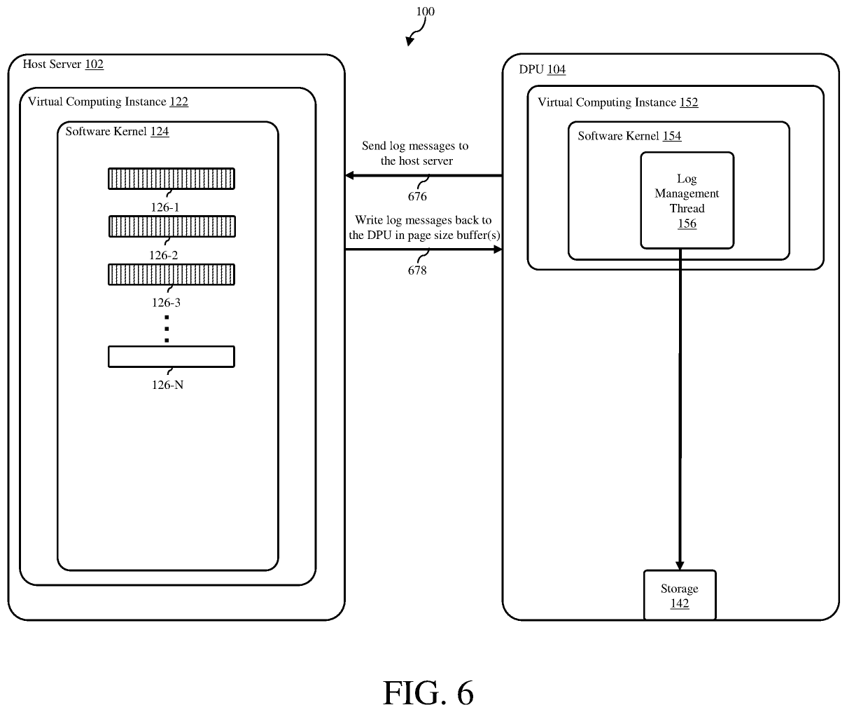

FIG. 6 depicts a log transmission operation 676 from the DPU 104 to the host server 102 and a log message write operation 678 from the host server to the DPU. For example, the DPU (e.g., the processor 134 executing program instructions from the software kernel 154 of the virtual computing instance 152) may transmit log messages to the host server using a log forwarding mechanism through the management link 166. In some embodiments, all of the logs of the DPU are forwarded to the host server to assure log data completeness. The host server (e.g., the processor 114 executing program instructions from the software kernel 124 of the virtual computing instance 122) stores the received logs in the dedicated log buffers 126-1, . . . , 126-N and can transmit the one or more stored log messages back to the DPU to be written back at a later point in time. For example, the host server can temporarily store the log data in the log buffers 126-1, . . . , 126-N and send the stored log data back to the DPU to avoid the data overflow in the log buffers 126-1, . . . , 126-N. In some embodiments, the host server (e.g., the processor 114 executing program instructions from the software kernel 124 of the virtual computing instance 122) decides when to write the log messages back to the DPU based on a ratio between a number of full log buffer or buffers in the log buffers 126-1, . . . , 126-N and a number of empty log buffer or buffers of the log buffers 126-1, . . . , 126-N. The host server may transmit the log messages stored in the log buffers back to the DPU to be stored in the storage 142 of the DPU when the ratio between the number of the full log buffer or buffers in the log buffers and the number of the empty log buffer or buffers of the log buffers exceeds a predetermined threshold. In some embodiments, the host server 102 decides when to write the log messages back to the DPU 104 based on a full buffer threshold, which is the number of full log buffer(s) that are currently on the host server. Once the full buffer threshold is reached, the host server starts sending log messages stored on the full log buffers back to the DPU to be stored in the storage 142 of the DPU. The full buffer threshold may be configured based on the total memory available on the host server and/or the current system load on the host server.

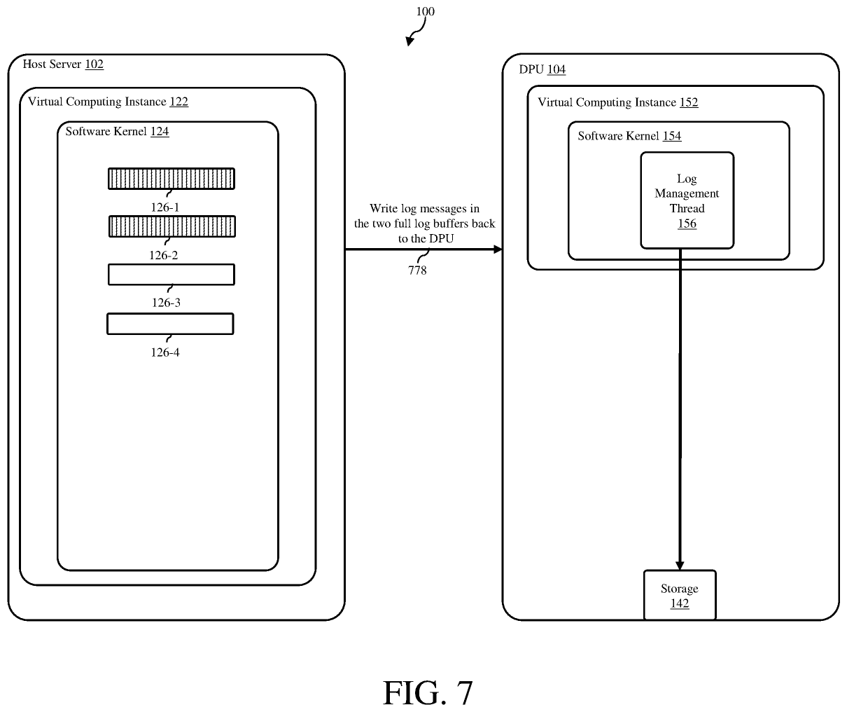

FIG. 7 depicts a log message write operation 778 from the host server 102 to the DPU 104, which is an example of the log message write operation 678 depicted in FIG. 6. In the example depicted in FIG. 7, the host server has two full log buffers 126-1, 126-2 and two empty log buffers 126-3, 126-4 out of a total of four log buffers (N being equal to 4), and the host server (e.g., the processor 114 executing program instructions from the software kernel 124 of the virtual computing instance 122) decides to write the received log messages back to the DPU if the total number of full log buffer(s) that are currently on the host server exceeds a predefined threshold, for example, 1. In this example, the host server sends the log messages stored on the full log buffers 126-1, 126-2 back to the DPU to be stored in the storage 142 of the DPU.

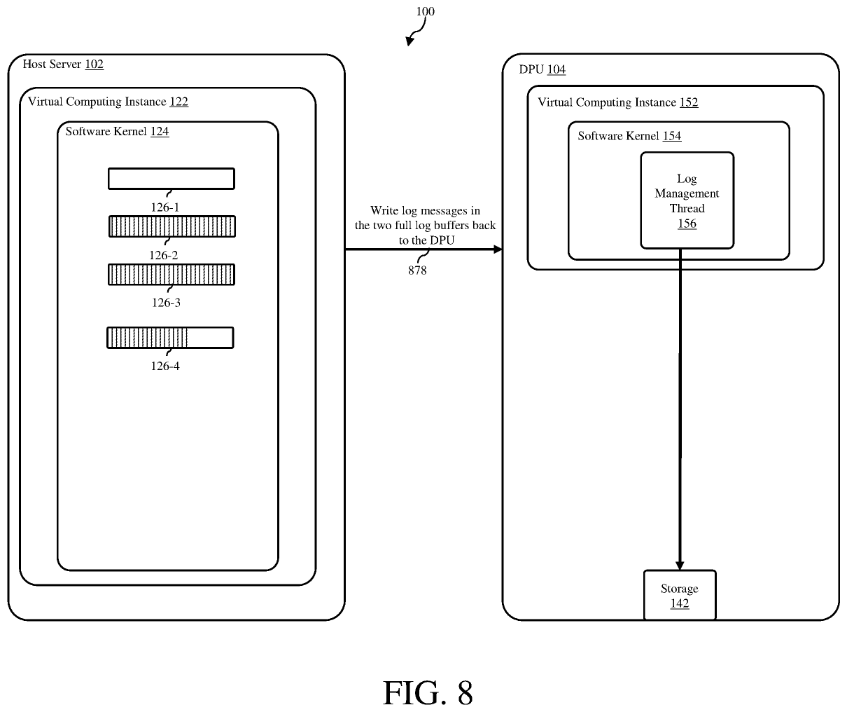

FIG. 8 depicts a log message write operation 878 from the host server 102 to the DPU 104, which is an example of the log message write operation 678 depicted in FIG. 6. In the example depicted in FIG. 8, the host server has one empty log buffer 126-1 (i.e., a log buffer with no data), two full log buffers 126-2, 126-3 (i.e., log buffers with all space within the log buffers are filled with log data from the DPU), and one half-empty-half-full log buffer 126-4 (i.e., a log buffer with some data but not all space within the log buffer is filled) out of a total of four log buffers (N being equal to 4), and the host server (e.g., the processor 114 executing program instructions from the software kernel 124 of the virtual computing instance 122) decides to write the received log messages back to the DPU if the ratio between full log buffer(s) and empty log buffer(s) that are currently on the host server exceeds a predefined threshold, for example, 1.5. In this example, the host server sends the log messages stored on the full log buffers 126-1, 126-2 back to the DPU to be stored in the storage 142 of the DPU. In some embodiments, the log buffers are implemented as a circular list. In a normal flush scenario, the full log buffers 126-2, 126-3 are flushed and the half-empty-half-full log buffer 126-4 is not flushed. Then, the log buffer 126-4 becomes the log buffer 126-1 and the flushed buffers are rotated. In case of catastrophic failures, because the logging is stopped at some point, all the data including half-filled buffer are flushed out.

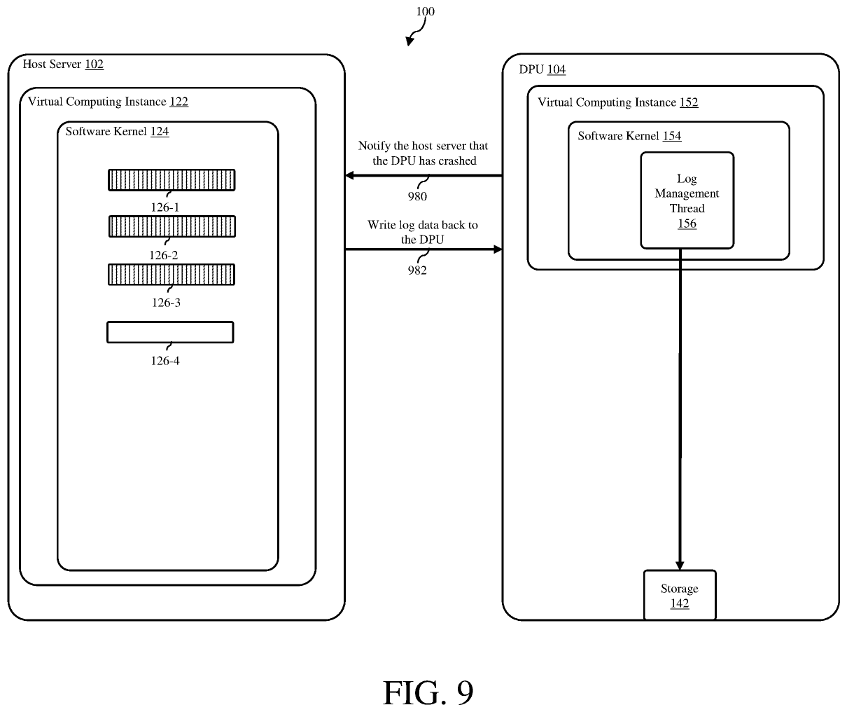

In some embodiments, the host server 102 transmits log messages stored on its log buffers 126-1, . . . , 126-N back to the DPU 104 to be stored in the storage 142 of the DPU in response to an emergency notification message from the DPU. FIG. 9 depicts an emergency notification operation 980 from the DPU 104 to the host server 102 to notify the host server that the DPU has crashed or failed, and a log message write operation 982 from the host server to the DPU. Specifically, the DPU notifies the host server that the DPU has crashed or failed through the management link 166. For example, when the DPU crashes due to some problem in the software and/or hardware, the host server will receive a signal indicating that the DPU has crashed. The host server may have three full log buffers 126-1, 126-2, 126-3 (i.e., log buffers with all space within the log buffers are filled with log data from the DPU) and one empty log buffer 126-4 (i.e., a log buffer with no data) out of a total of four log buffers (N being equal to 4). The host server can write all valid log data stored on the log buffers 126-1, 126-2, 126-3 to the DPU (as the log buffer 126-4 is empty with no data). Once the DPU receives all the log data from the host server, the DPU can write the log data to the storage 142 (e.g., eMMCs) as a part of crash handling procedure.

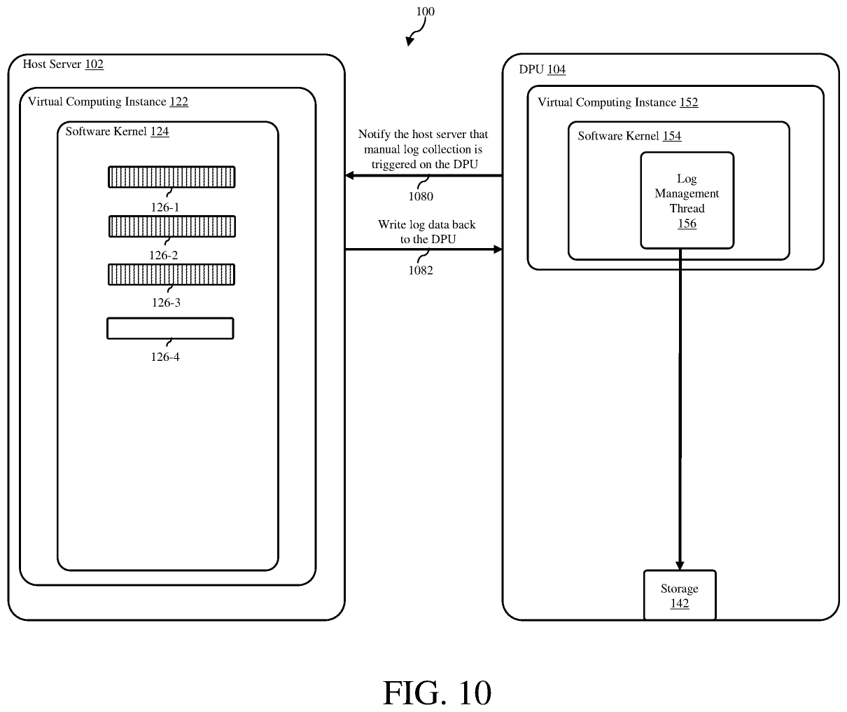

In some embodiments, the host server 102 transmits log messages stored on its log buffers 126-1, . . . , 126-N back to the DPU 104 to be stored in the storage 142 of the DPU in response to a manual log collection message from the DPU. FIG. 10 depicts an on-demand log collection operation 1080 from the DPU 104 to the host server 102 and a log message write operation 1082 from the host server to the DPU. Specifically, when a user initiates a manual log collection on the DPU, the DPU (e.g., the processor 134 executing program instructions from the software kernel 154 of the virtual computing instance 152) can send a signal to the host server to notify the host server that a manual log collection is triggered on the DPU. The host server may have three full log buffers 126-1, 126-2, 126-3 and one empty log buffer 126-4 out of a total of four log buffers (N being equal to 4). The host server (e.g., the processor 114 executing program instructions from the software kernel 124 of the virtual computing instance 122) can write all valid log data stored on the log buffers 126-1, 126-2, 126-3 to the DPU (as the log buffer 126-4 is empty with no data). Once the DPU receives all the log data from the host server, the DPU can write the log data to the storage 142 (e.g., eMMCs) as a part of log collection procedure.

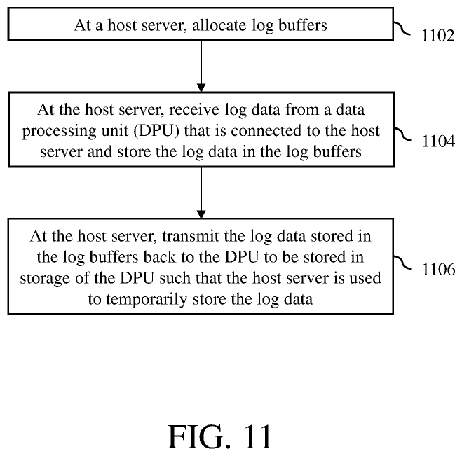

A computer-implemented method in accordance with an embodiment of the invention is described with reference to a process flow diagram of FIG. 11. At block 1102, at a host server, log buffers are allocated. At block 1104, at the host server, log data is received from a DPU that is connected to the host server and the log data is stored in the log buffers. At block 1106, at the host server, the log data stored in the log buffers is transmitted back to the DPU to be stored in storage of the DPU such that the host server is used to temporarily store the log data.

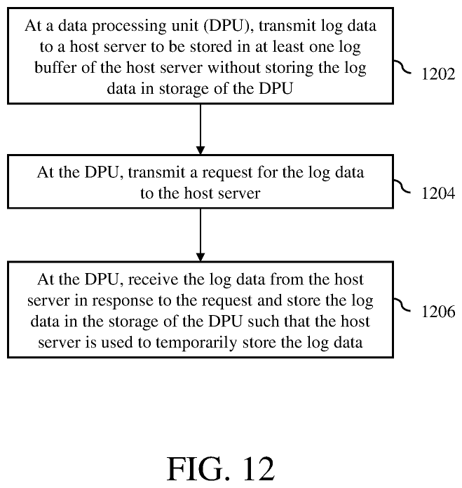

A computer-implemented method in accordance with an embodiment of the invention is described with reference to a process flow diagram of FIG. 12. At block 1202, at a DPU, log data is transmitted to a host server to be stored in at least one log buffer of the host server without storing the log data in storage of the DPU. At block 1204, at the DPU, a request for the log data is transmitted to the host server. At block 1206, at the DPU, the log data is received from the host server in response to the request and the log data is stored in the storage of the DPU such that the host server is used to temporarily store the log data.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer usable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disc, and an optical disc. Current examples of optical discs include a compact disc with read only memory (CD-ROM), a compact disc with read/write (CD-R/W), a digital video disc (DVD), and a Blu-ray disc.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer-implemented method comprising:
at a host server, allocating a plurality of log buffers;
at the host server, receiving log data from a data processing unit (DPU) that is connected to the host server and storing the log data in the log buffers; and
at the host server, transmitting the log data stored in the log buffers back to the DPU to be stored in storage of the DPU such that the host server is used to temporarily store the log data.

2. The computer-implemented method of claim 1, wherein the storage of the DPU comprises a flash-based storage device.

3. The computer-implemented method of claim 2, wherein the flash-based storage device comprises an embedded MultiMediaCard (eMMC).

4. The computer-implemented method of claim 1, further comprising:
at the host server, requesting a page size of the storage of the DPU from the DPU; and
at the host server, receiving the page size of the storage of the DPU from the DPU,
wherein allocating the log buffers comprises:
at the host server, allocating the log buffers to have a page size that is identical to the page size of the storage of the DPU.

5. The computer-implemented method of claim 1, wherein allocating the log buffers comprises:
allocating a plurality of virtual buffers in a software kernel of a virtual computing instance of the host server.

6. The computer-implemented method of claim 1, wherein transmitting the log data stored in the log buffers back to the DPU to be stored in the storage of the DPU comprises:
at the host server, transmitting all of the log data stored in the log buffers back to the DPU to be stored in the storage of the DPU.

7. The computer-implemented method of claim 1, wherein transmitting the log data stored in the log buffers back to the DPU to be stored in the storage of the DPU comprises:
at the host server, transmitting the log data stored in the log buffers back to the DPU to be stored in the storage of the DPU based on a ratio between a number of full log buffer or buffers in the log buffers and a number of empty log buffer or buffers of the log buffers.

8. The computer-implemented method of claim 7, wherein transmitting the log data stored in the log buffers back to the DPU to be stored in the storage of the DPU based on the ratio between the number of the full log buffer or buffers in the log buffers and the number of the empty log buffer or buffers of the log buffers comprises:
at the host server, transmitting the log data stored in the log buffers back to the DPU to be stored in the storage of the DPU when the ratio between the number of the full log buffer or buffers in the log buffers and the number of the empty log buffer or buffers of the log buffers exceeds a predetermined threshold.

9. The computer-implemented method of claim 1, wherein transmitting the log data stored in the log buffers back to the DPU to be stored in the storage of the DPU comprises:
at the host server, transmitting the log data stored in the log buffers back to the DPU to be stored in the storage of the DPU based on a total number of full log buffers in the log buffers.

10. The computer-implemented method of claim 9, wherein transmitting the log data stored in the log buffers back to the DPU to be stored in the storage of the DPU based on the total number of the full log buffers in the log buffers comprises:
at the host server, transmitting the log data stored in the log buffers back to the DPU to be stored in the storage of the DPU when the total number of the full log buffers in the log buffers exceeds a predetermined threshold.

11. The computer-implemented method of claim 1, further comprising receiving a notification of a failure of the DPU, wherein at the host server, transmitting the log data stored in the log buffers back to the DPU to be stored in the storage of the DPU comprises:
at the host server, transmitting the log data stored in the log buffers back to the DPU to be stored in the storage of the DPU in response to the notification of the failure of the DPU.

12. The computer-implemented method of claim 1, further comprising at the host server, receiving a notification that a manual log collection is triggered at the DPU, wherein at the host server, transmitting the log data stored in the log buffers back to the DPU to be stored in the storage of the DPU comprises:
at the host server, transmitting the log data stored in the log buffers back to the DPU to be stored in the storage of the DPU in response to the notification that the manual log collection is triggered at the DPU.

13. The computer-implemented method of claim 1, wherein the DPU is connected to the host server through a Peripheral Component Interconnect Express (PCIe) interface.

14. A non-transitory computer-readable storage medium containing program instructions, wherein execution of the program instructions by one or more processors causes the one or more processors to perform steps comprising:
at a host server, allocating a plurality of log buffers;
at the host server, receiving log data from a data processing unit (DPU) that is connected to the host server and storing the log data in the log buffers; and
at the host server, transmitting the log data stored in the log buffers back to the DPU to be stored in storage of the DPU such that the host server is used to temporarily store the log data.

15. The non-transitory computer-readable storage medium of claim 14, wherein the storage of the DPU comprises a flash-based storage device.

16. The non-transitory computer-readable storage medium of claim 15, wherein the flash-based storage device comprises an embedded MultiMediaCard (eMMC).

17. The non-transitory computer-readable storage medium of claim 14, wherein the steps further comprise:
at the host server, requesting a page size of the storage of the DPU from the DPU; and
at the host server, receiving the page size of the storage of the DPU from the DPU, and
wherein at the host server, allocating the log buffers comprises:
at the host server, allocating the log buffers to have a page size that is identical to the page size of the storage of the DPU.

18. The non-transitory computer-readable storage medium of claim 14, wherein at the host server, transmitting the log data stored in the log buffers back to the DPU to be stored in the storage of the DPU comprises:
at the host server, transmitting the log data stored in the log buffers back to the DPU to be stored in the storage of the DPU when a ratio between a number of full log buffer or buffers in the log buffers and a number of empty log buffer or buffers of the log buffers exceeds a predetermined threshold.

19. The non-transitory computer-readable storage medium of claim 14, wherein at the host server, transmitting the log data stored in the log buffers back to the DPU to be stored in the storage of the DPU comprises:
at the host server, transmitting the log data stored in the log buffers back to the DPU to be stored in the storage of the DPU when a total number of full log buffers in the log buffers exceeds a predetermined threshold.

20. A system comprising:
memory; and
at least one processor configured to:
allocate a plurality of log buffers;
receive log data from a data processing unit (DPU) and store the log data in the log buffers; and
transmit the log data stored in the log buffers back to the DPU to be stored in storage of the DPU such that the host server is used to temporarily store the log data.
